(19) United States
(12) Patent Application Publication
(10) Pub. No.: US 2026/0226876 A1
(43) Pub. Date: Aug. 6, 2026

(54) CONTROLLER FOR VEHICLE

(71) Applicant: TOYOTA JIDOSHA KABUSHIKI KAISHA, Toyota-shi (JP)

(72) Inventors: Yuuki MAKINO, Aichi-gun (JP); Masafumi YAMAMOTO, Nagakute-shi (JP)

(21) Appl. No.: 19/392,158

(22) Filed: Nov. 18, 2025

(30) Foreign Application Priority Data
Jan. 31, 2025 (JP) 2025-014818

(51) Int. Cl. F02N 11/08

(52) U.S. Cl. CPC F02N 11/0803

(57) ABSTRACT

A vehicle includes an internal combustion engine, a battery, and a first MG that performs motoring of an internal combustion engine by receiving electric power from the battery. The controller includes processing circuitry. The processing circuitry executes a determination process based on an execution condition including an engine start time that is a time from an engine stop to a next start of engine operation. In the determination process, whether a scavenging operation should be executed is determined. In the scavenging operation, the motoring is performed in a state in which fuel injection of the internal combustion engine is stopped.

### CROSS-REFERENCE TO RELATED APPLICATIONS

This application is based upon and claims the benefit of priority from Japanese Patent Application No. 2025-014818, filed on January 31, 2025, the entire contents of which are incorporated herein by reference.

### BACKGROUND

### 1. Field

The present disclosure relates to a controller for a vehicle.

### 2. Description of Related Art

For example, JP2018-39347A discloses a vehicle equipped with an electric motor that performs motoring of an internal combustion engine by receiving electric power from a battery. In this vehicle, when the engine is stopped and prescribed conditions are satisfied, a scavenging operation is performed. During the scavenging operation, motoring of the internal combustion engine is performed while fuel injection is halted, thereby removing moisture from the combustion chamber. Accordingly, it is possible to prevent a reduction in subsequent engine startability due to adhesion of moisture to the ignition plug during engine stop.

When the period from an engine stop to the next start of engine operation, that is, an engine start time is relatively short, the temperature of the internal combustion engine does not decrease significantly. In such cases, a scavenging operation is often unnecessary. However, in the above-described related art, since it is determined whether the scavenging operation should be executed based on the condition when the engine is stopped, the scavenging operation may be executed more frequently than required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller for a vehicle is provided. The vehicle includes an internal combustion engine, a battery, and an electric motor that performs motoring of the internal combustion engine by receiving electric power from the battery. The controller includes processing circuitry. The processing circuitry is configured to execute a determination process of determining whether to execute a scavenging operation in which the motoring is performed in a state in which fuel injection of the internal combustion engine is stopped, based on an execution condition including an engine start time that is a time from an engine stop to a next start of engine operation.

Other features and aspects will be apparent from the following detailed description, the drawings, and the claims.

### BRIEF DESCRIPTION OF THE DRAWINGS

FIG. 1 is a schematic diagram showing the configuration of a vehicle according to an embodiment.

FIG. 2 is a flowchart illustrating a procedure of processes executed by processing circuitry according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A controller for a vehicle according to an embodiment will now be described.

### Configuration of Vehicle

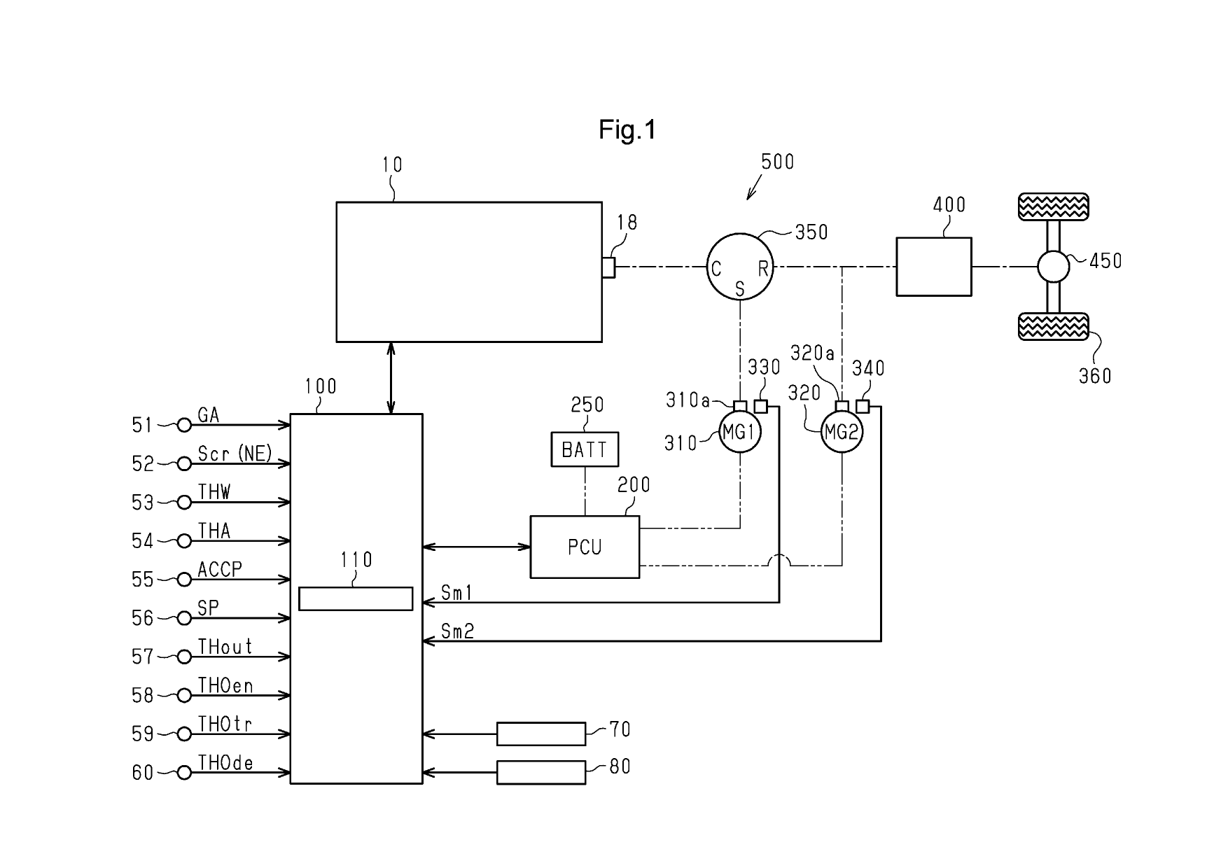

As shown in FIG. 1, a vehicle 500 is equipped with an internal combustion engine 10 as a power source and an electric motor. The internal combustion engine 10 uses hydrogen as fuel.

The internal combustion engine 10 has a crankshaft 18 mechanically connected to a carrier C of a planetary gear mechanism 350 constituting a power split device.

A sun gear S of the planetary gear mechanism 350 is mechanically connected to a rotation shaft 310a of a first motor-generator (hereinafter, referred to as a first MG) 310.

A ring gear R of the planetary gear mechanism 350 is connected to a rotation shaft 320a of a second motor-generator (hereinafter referred to as a second MG) 320. The ring gear R is connected to an input shaft of the speed change mechanism 400. An output shaft of the speed change mechanism 400 is connected to drive wheels 360 of the vehicle 500 via a differential gear 450.

The first MG 310 functions as a power generator that generates electric power by using the engine power, and also functions as a start-up cranking motor that cranks the crankshaft 18 when the internal combustion engine is started. The first MG 310 is a motor that performs motoring of the internal combustion engine 10 by applying torque to the crankshaft 18.

The second MG 320 functions as a motor that generates a driving force of the drive wheels 360, and functions as a power generator that generates electric power by regeneration during deceleration of the vehicle 500.

The first MG 310 and the second MG 320 exchange electric power with a battery 250 via a power control unit (PCU) 200. The battery 250 is charged by using the output of the internal combustion engine 10 and supplies electric power to the first MG 310 and the second MG 320. The PCU 200 includes a converter that boosts a DC voltage input from the battery 250 and outputs the boosted DC voltage, inverters that convert the DC voltage boosted by the converter into an alternating-current voltage and output the AC voltage to each MG 310, 320, and the like.

### Controller

The controller 100 controls the output and the exhaust property of the internal combustion engine 10 by controlling the intake air amount, the fuel injection amount, and the ignition timing. The controller 100 operates the inverters via the PCU 200 in order to control the torque of the first MG 310. The controller 100 operates the inverters via the PCU 200 in order to control the torque of the second MG 320.

The controller 100 includes processing circuitry 110. The processing circuitry 110 includes a CPU that executes various processes in accordance with programs, and a ROM in which various programs are stored.

The controller 100 refers to detection values of various sensors. For example, the controller 100 refers to a detection value of an air flow meter 51 that detects an intake air amount GA of the internal combustion engine 10. The controller 100 refers to a detection signal Scr of a crank angle sensor 52 that detects a rotation angle of the crankshaft 18. The controller 100 refers to a detection value of a coolant temperature sensor 53 that detects a coolant temperature THW that is a temperature of coolant of the internal combustion engine 10. The controller 100 refers to a detection value of an intake air temperature sensor 54 that detects an intake air temperature THA that is a temperature of intake air of the internal combustion engine 10. The controller 100 refers to a detection signal of an accelerator position sensor 55 that detects an accelerator operation amount ACCP that is an operation amount of an accelerator pedal operated by a driver of the vehicle 500. The controller 100 refers to a detection signal of a speed sensor 56 that detects a vehicle speed SP of the vehicle 500. The controller 100 refers to a detection signal of an outside air temperature sensor 57 that detects the outside air temperature THout. The controller 100 refers to a detection signal of a first oil temperature sensor 58 that detects a first oil temperature THOen that is the temperature of the lubricating oil of the internal combustion engine 10. The controller 100 refers to a detection signal of a second oil temperature sensor 59 that detects a second oil temperature THOtr that is the temperature of the lubricant of the speed change mechanism 400. The controller 100 refers to a detection signal of a third oil temperature sensor 60 that detects a third oil temperature THOde that is the temperature of the lubricating oil of the differential gear 450. The controller 100 refers to a signal Sm1 outputted from a first rotation angle sensor 330 that detects the rotation angle of the first MG 310 and a signal Sm2 outputted from a second rotation angle sensor 340 that detects the rotation angle of the second MG 320.

The controller 100 calculates the engine rotation speed NE based on the detection signal Scr of the crank angle sensor 52. In addition, the controller 100 calculates an engine load factor KL based on the engine rotation speed NE and the intake air amount GA. The engine load factor KL represents the ratio of the current cylinder inflow air amount to the cylinder inflow air amount at the time of steady operation of the internal combustion engine 10 in a full load state at the current engine rotation speed NE. The cylinder inflow air amount is the amount of air that flows into each cylinder in the intake stroke.

The controller 100 acquires current location information LI of the vehicle 500 from a global positioning system (GPS) 70 included in the vehicle 500. The controller 100 is connected to a communication device 80. The communication device 80 is connected to a network outside the vehicle by wireless communication. A data center including a server and the like is connected to the network. The controller 100 acquires an outside air temperature THoutf, which is a predicted value of the outside air temperature at the designated time, from the datacenter.

### Scavenging Operation

The internal combustion engine 10 uses hydrogen as fuel. Therefore, as compared with an engine using gasoline or the like as fuel, moisture derived from fuel is more likely to be generated in the combustion chamber. If moisture adheres to the ignition plug of the internal combustion engine 10 while the engine is stopped, the engine startability may deteriorate.

Therefore, the controller 100 performs a scavenging operation for removing moisture in the combustion chamber. When the scavenging operation is performed, motoring of the internal combustion engine 10 is performed in a state in which fuel injection is stopped. Motoring of the internal combustion engine 10 is performed by driving the first MG 310 supplied with electric power from the battery 250.

### Whether to Execute Scavenging Operation

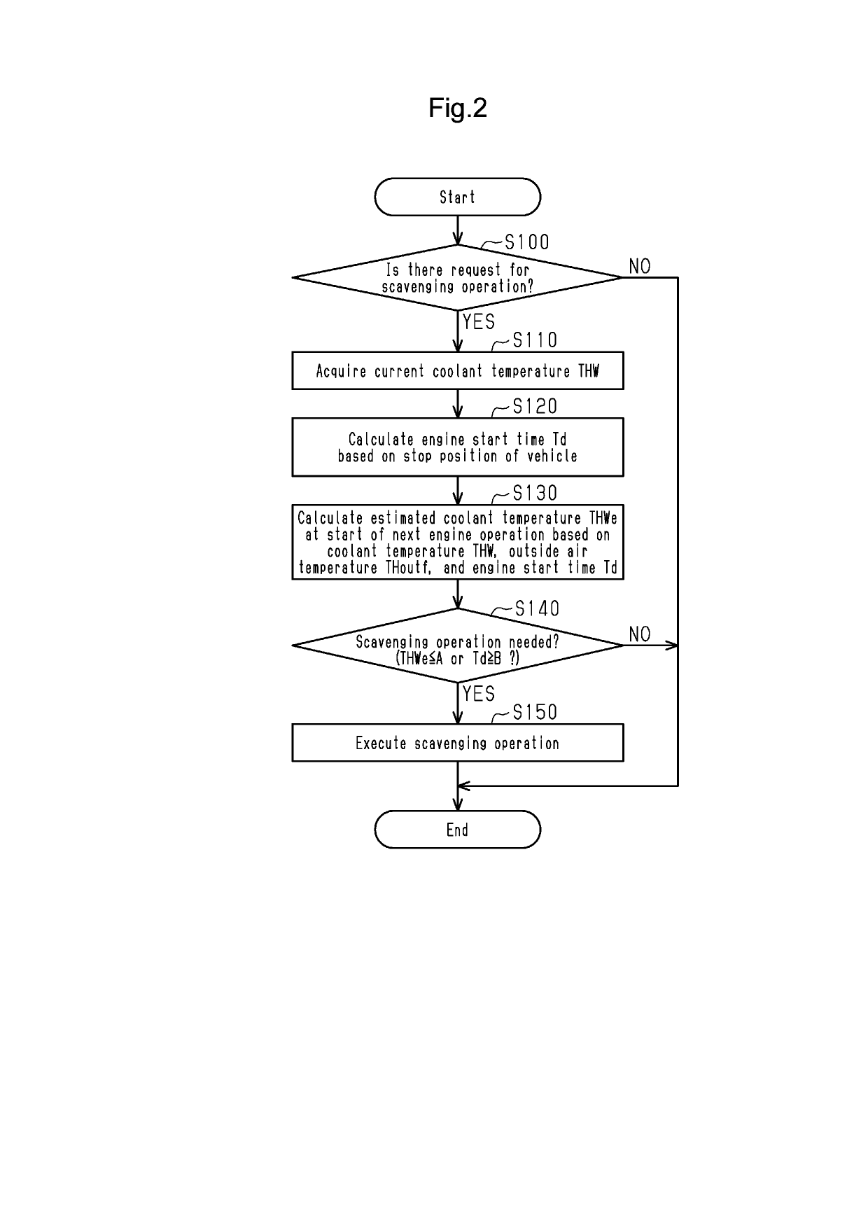

FIG. 2 shows a procedure of processes executed by the processing circuitry 110 to determine whether the scavenging operation should be executed. The execution of this process is started when the vehicle 500 stops and the operation of the internal combustion engine 10 is stopped. In the following description, the number of each step is represented by the letter S followed by a numeral.

In the series of processes shown in FIG. 2, first, the processing circuitry 110 executes a determination process of determining whether there is a request for the scavenging operation described above (S100). In the process of S100, the processing circuitry 110 determines that the scavenging operation is requested when the amount of moisture in the combustion chamber of the internal combustion engine 10 is greater than or equal to a prescribed threshold. The amount of moisture in the combustion chamber is calculated by the processing circuitry 110 in another process. For example, the processing circuitry 110 calculates the amount of moisture based on a physical quantity correlated with the amount of moisture in the combustion chamber, a model equation, and the like. Examples of the physical quantity correlated with the amount of moisture in the combustion chamber include the engine rotation speed NE, the coolant temperature THW, the intake air temperature THA, the air-fuel ratio of the air-fuel mixture, the combustion temperature of the air-fuel mixture, the fuel injection amount, the fuel temperature, and the wall temperature of the intake manifold. A sensor may be used to detect the amount of moisture.

In the process of S100, when it is determined that the scavenging operation is being requested (S100: YES), the processing circuitry 110 acquires the current coolant temperature THW (S110). The processing circuitry 110 acquires the coolant temperature THW as a value correlated with the temperature of the internal combustion engine 10.

Next, the processing circuitry 110 calculates engine start time Td based on the stop position of the vehicle 500 (S120). The engine start time Td is a time from an engine stop to the next start of engine operation, and is a predicted value calculated in response to the shutdown of the internal combustion engine 10. In the process of S120, the processing circuitry 110 obtains the stop position of the vehicle 500 based on the acquired location information LI. The processing circuitry 110 calculates the engine start time Td by reading the engine start time Td set in advance for the obtained stop position from the memory or the like. The process of S120 corresponds to an estimation process of estimating the engine start time Td.

Next, the processing circuitry 110 calculates an estimated coolant temperature THWe, which is an estimated value of the coolant temperature THW at the start of the next engine operation (S130). The coolant temperature THW at the start of the next engine operation is the coolant temperature THW at the time when the engine start time Td has elapsed. In the process in S130, the processing circuitry 110 calculates the estimated coolant temperature THWe based on, for example, the coolant temperature THW acquired in S110, the outside air temperature THoutf at the engine start time Td acquired from the datacenter, and the engine start time Td.

Next, the processing circuitry 110 determines whether the scavenging operation is necessary (S140). The process of S140 corresponds to a determination process of determining whether the scavenging operation should be executed. In the process of S140, the processing circuitry 110 determines that the scavenging operation is necessary when the logical disjunction of the following execution conditions is true.

Execution Condition (A): The estimated coolant temperature THWe is less than or equal to a prescribed determination value A. The determination value A is, for example, the upper limit value of the coolant temperature THW at which the scavenging operation is desired to be performed.

Execution condition (B): The engine start time Td is greater than or equal to a prescribed determination value B. The determination value B is, for example, the minimum value of the engine start time Td at which the scavenging operation is desired to be performed.

In the process of S140, when it is determined that the scavenging operation is necessary (S140: YES), the processing circuitry 110 executes the scavenging operation (S150).

In a case in which the process of S150 is completed, in a case in which a negative determination is made in the process of S100, or in a case in which a negative determination is made in the process of S140, the processing circuitry 110 ends the process.

Operation and Advantages of the Present Embodiment

(1) The processing circuitry 110 executes the determination processing of determining whether to execute the scavenging operation, in which motoring is performed in a state in which the fuel injection of the internal combustion engine 10 is stopped, on the basis of the execution condition including the engine start time Td, which is time from the engine stop to the next engine operation start.

That is, the execution condition for determining whether to execute the scavenging operation includes the engine start time Td, which is the time from the engine stop to the start of the next engine operation. Accordingly, it is possible to determine whether the scavenging operation should be performed based on the engine start time Td. This prevents the scavenging operation from being performed more frequently than required.

(2) The processing circuitry 110 executes the estimation process of estimating the engine start time Td. The execution condition includes a condition that the estimated engine start time Td is greater than or equal to the prescribed determination value B.

Accordingly, when the engine start time Td is longer than or equal to the determination value B and thus it can be determined that the scavenging operation is necessary, the scavenging operation is performed.

(3) In the estimation process, the engine start time Td is estimated based on the location information LI of the vehicle 500.

When the vehicle 500 is stopped on a road, in a parking lot of a store, at a filling station, or the like, the engine start time Td tends to be short. In contrast, when the vehicle 500 is parked in a parking lot where the vehicle 500 is usually stored, the engine start time Td tends to be long. Accordingly, the engine start time Td can be estimated based on the location information LI of the vehicle 500. This allows the engine start time Td to be estimated by executing the estimation process.

(4) The fuel of the internal combustion engine 10 is hydrogen. Hydrogen tends to generate a larger amount of moisture during combustion than gasoline or the like containing hydrocarbon as a main component. Accordingly, the amount of moisture adhering to the ignition plug during engine stop may increase. In such an internal combustion engine 10, the scavenging operation described above can be appropriately performed.

### Modifications

The above-described embodiment may be modified as follows. The above-described embodiment and the following modifications can be combined if the combined modifications remain technically consistent with each other.

The processing circuitry 110 acquires the coolant temperature THW as a value correlated with the temperature of the internal combustion engine 10. The processing circuitry 110 may acquire another value as the value correlated with the temperature of the internal combustion engine 10. The other values are, for example, the first oil temperature THOen, the second oil temperature THOtr, and the third oil temperature THOde. When the vehicle 500 includes an auxiliary transmission, the other value is, for example, the oil temperature of the lubricating oil of the auxiliary transmission. The other value is, for example, the temperature of the first MG 310 or the temperature of the second MG 320. The other value is, for example, the temperature of the battery 250. The other value is, for example, the temperature of the exhaust system of the internal combustion engine 10. The other value is, for example, the outside air temperature THout.

The processing circuitry 110 may calculate the estimated coolant temperature THWe based on the coolant temperature THW acquired at the S110, the outside air temperature THout when the engine is stopped, and the engine start time Td.

The calculation of the estimated coolant temperature THWe and the execution condition (A) may be omitted.

When an operation plan is set for the vehicle 500, the engine start time Td may be estimated based on the operation plan.

The information on the temperature and the engine start time Td may be acquired from a terminal connected by wire.

The number of motor-generators included in the vehicle 500 can be changed as appropriate.

The vehicle 500 is a series-parallel hybrid electric vehicle, but may be another type of hybrid electric vehicle. The hybrid electric vehicle may be, for example, a parallel hybrid electric vehicle.

The fuel of the internal combustion engine 10 may be other than hydrogen.

The controller 100 is not limited to a device that includes a CPU and a memory module and executes software processing. For example, the controller 100 may include hardware circuits, for example, an application-specific integrated circuit (ASIC)), dedicated to executing at least part of the processes executed by the software in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. The program storage device, which is a computer-readable medium, includes any type of medium that is accessible by a general-purpose computer or a dedicated computer. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, the vehicle including an internal combustion engine, a battery, and an electric motor that performs motoring of the internal combustion engine by receiving electric power from the battery, the controller comprising processing circuitry,
wherein the processing circuitry is configured to execute a determination process of determining whether to execute a scavenging operation in which the motoring is performed in a state in which fuel injection of the internal combustion engine is stopped, based on an execution condition including an engine start time that is a time from an engine stop to a next start of engine operation.

2. The controller for the vehicle according to claim 1, wherein
the processing circuitry is configured to execute an estimation process of estimating the engine start time, and
the execution condition includes a condition that the estimated engine start time is longer than or equal to a prescribed determination value.

3. The controller for the vehicle according to claim 2, wherein the processing circuitry is configured to estimate, in the estimation process, the engine start time based on location information of the vehicle.

4. The controller for the vehicle according to claim 1, wherein a fuel of the internal combustion engine is hydrogen.
